(19) United States
(12) Patent Application Publication
(10) Pub. No.: US 2021/0390603 A1
(43) Pub. Date: Dec. 16, 2021

(54) SERVER APPARATUS AND INFORMATION PROVISION METHOD OF COMPONENT SELECTION SYSTEM, AND COMPUTER PROGRAM FOR COMPONENT SELECTION SYSTEM

(71) Applicant: MISUMI Group Inc., Tokyo (JP)

(72) Inventors: Shingo OKANO, Tokyo (JP); Minoru KAGE, Tokyo (JP); Nobuaki EBI, Tokyo (JP); Tetsuya KAWANO, Tokyo (JP); Kenji TAKAHASHI, Tokyo (JP); Lei LI, Tokyo (JP)

(73) Assignee: MISUMI Group Inc., Tokyo (JP)

(21) Appl. No.: 17/283,802

(22) PCT Filed: Dec. 20, 2019
(86) PCT No.: PCT/JP2019/050125

§ 371 Date: Apr. 8, 2021

(30) Foreign Application Priority Data
Dec. 28, 2018 (JP) 2018-248382

(51) Int. Cl. G06Q 30/06

(52) U.S. Cl. CPC G06Q 30/0621

(57) ABSTRACT

A computer of an ordering supporting server executes: a process of acquiring information necessary for specifying a product model number corresponding to a specific product from a terminal apparatus; a process of specifying a product model number corresponding to the specific product on the basis of the acquired information; a process of specifying, on the basis of constituent component data associated with the specific product, a component model number associated with the product model number while defining a value of a component variable part associated with a value of a variable part of the product model number according to a rule for an associated relation set between the model numbers; and a process of providing the specified component identification information to the terminal apparatus.

### CROSS-REFERENCE TO RELATED PATENT APPLICATIONS

This application is a U.S. National Phase Application under 35 U.S.C. § 371 of International Patent Application No. PCT/JP2019/050125 filed on Dec. 20, 2019 and claims the benefit of priority to Japanese Patent Application No. 2018-248382 filed on Dec. 28, 2018, all of which are incorporated herein by reference in their entireties. The International Application was published in Japanese on Jul. 2, 2020 as International Publication No. WO/2020/137896 under PCT Article 21(2).

### FIELD OF THE INVENTION

The present invention relates to a server apparatus and so forth for providing information necessary for allowing a user to select a component configuring a product to a terminal apparatus.

### BACKGROUND OF THE INVENTION

As a system for allowing a user to purchase a constituent component of a mechanical product, a system has been proposed in which, for example, a screen image of a list of consumable components that are about to be replaced from among constituent components of a product introduced by a user is displayed on a terminal apparatus such that the user selects a component the user desires to purchase from the screen image of the list (for example, refer to Japanese Patent Laid-Open No. 2011-215732).

### CITATION LIST

### Patent Literature

[PTL 1]
Japanese Patent Laid-Open No. 2011-215732

### Technical Problems

In a related-art system, a constituent component of a product is specified according to data that describes products and constituent components of the products in an associated relation with each other, and the associated relation is determined uniquely depending upon the product. It is customary that a component group configuring a product includes a great number of components depending upon differences of specifications of the dimension and so forth although they are same in basic configuration. Therefore, even if a user designates and tries to buy, for example, a component that is not about to be replaced, a guide principle for allowing the user to select a correct component is not given to the user, and it is difficult or impossible for the user to reach the component targeted by the user. Further, when a user considers change of a component in such a case that the user wants to change specifications of part of a product, it is also difficult or impossible for the user to decide what component is to be selected. In this manner, the related-art system lacks in flexibility or degree of freedom in selection of a component.

Therefore, it is an object of the present invention to provide a server apparatus and so forth of a component selection system by which the flexibility and the degree of freedom in selection of a component can be improved.

### SUMMARY OF THE INVENTION

### Solution to Problems

A server apparatus according to one aspect of the present invention is a server apparatus for a component selection system. In the component selection system, for each of a plurality of products, product identification information unique to each product is set, the product identification information being a combination of a product common part set in common to products that are same in configuration except differences of specifications, and a product variable part set to different values depending upon the specifications. For each of a plurality of components configuring each product, component identification information unique to each component is set, the component identification information being a combination of a component common part set in common to components that are same in configuration except differences of specifications, and a component variable part set to different values depending upon the specifications. The server apparatus is applied to the component selection system in which values of the product variable part of the product identification information and values of the component variable part of the component identification information are associated with each other according to a predetermined rule. The server apparatus provides information for allowing a user to select at least one component configuring a specific product to a terminal apparatus used by the user. The server apparatus includes information acquisition means for acquiring information for specifying the product identification information corresponding to the specific product from the terminal apparatus, product identification information specification means for specifying the product identification information corresponding to the specific product on a basis of the information acquired by the information acquisition means, component identification information specification means for specifying, on a basis of constituent component data that describes an associated relation between at least the product common part of the product identification information and at least the component common part of the component identification information, the component identification information associated with the product identification information specified by the product identification information specification means while defining a value of the component variable part associated with a value of the product variable part according to the predetermined rule, and information provision means for providing the component identification information specified by the component identification information specification means to the terminal apparatus. The information acquisition means acquires first information that designates the product identification information corresponding to the specific product in a state in which a value of at least part of variables of the product variable part is undefined and second information that designates a value of the variable in the undefined state, from the terminal apparatus. The product identification information specification means specifies the product identification information corresponding to the specific product on a basis of the first information and the second information.

An information provision method for a component selection system according to one aspect of the present invention is an information provision method for a component selection system in which, for each of a plurality of products, product identification information unique to each product is set, the product identification information being a combination of a product common part set in common to products that are same in configuration except differences of specifications and a product variable part set to different values depending upon the specifications, and for each of a plurality of components configuring each product, component identification information unique to each component is set, the component identification information being a combination of a component common part set in common to components that are same in configuration except differences of specifications and a component variable part set to different values depending upon the specifications. The information provision method is applied to the component selection system in which values of the product variable part of the product identification information and values of the component variable part of the component identification information are associated with each other according to a predetermined rule. Information for allowing a user to select at least one component configuring a specific product is provided from a server apparatus to a terminal apparatus used by the user. The information provision method causes a computer of the server apparatus to execute an information acquisition step of acquiring information for specifying the product identification information corresponding to the specific product from the terminal apparatus, a product identification information specification step of specifying the product identification information corresponding to the specific product on a basis of the information acquired by the information acquisition step, a component identification information specification step of specifying, on a basis of constituent component data that describes an associated relation between at least the product common part of the product identification information and at least the component common part of the component identification information, the component identification information associated with the product identification information specified by the product identification information specification step while defining a value of the component variable part associated with a value of the product variable part according to the predetermined rule, and an information provision step of providing the component identification information specified by the component identification information specification step to the terminal apparatus. At the information acquisition step, first information that designates the product identification information corresponding to the specific product in a state in which a value of at least part of variables of the product variable part is undefined and second information that designates a value of the variable in the undefined state are acquired from the terminal apparatus. At the product identification information specification step, the product identification information corresponding to the specific product is specified on a basis of the first information and the second information.

A computer program according to one aspect of the present invention is a computer program for a computer of a server apparatus provided in a component selection system. In the component selection system, for each of a plurality of products, product identification information unique to each product is set, the product identification information being a combination of a product common part set in common to products that are same in configuration except differences of specifications, and a product variable part set to different values depending upon the specifications. For each of a plurality of components configuring each product, component identification information unique to each component is set, the component identification information being a combination of a component common part set in common to components that are same in configuration except differences of specifications, and a component variable part set to different values depending upon the specifications. Values of the product variable part of the product identification information and values of the component variable part of the component identification information are associated with each other according to a predetermined rule. The computer program causes the computer to function such that information for allowing a user to select at least one component configuring a specific product is provided to a terminal apparatus used by the user. The computer program causes the computer to function as information acquisition means for acquiring information for specifying the product identification information corresponding to the specific product from the terminal apparatus, product identification information specification means for specifying the product identification information corresponding to the specific product on a basis of the information acquired by the information acquisition means, component identification information specification means for specifying, on a basis of constituent component data that describes an associated relation between at least the product common part of the product identification information and at least the component common part of the component identification information, the component identification information associated with the product identification information specified by the product identification information specification means while defining a value of the component variable part associated with a value of the product variable part according to the predetermined rule, and information provision means for providing the component identification information specified by the component identification information specification means to the terminal apparatus. The information acquisition means acquires first information that designates the product identification information corresponding to the specific product in a state in which a value of at least part of variables of the product variable part is undefined and second information that designates a value of the variable in the undefined state, from the terminal apparatus. The product identification information specification means specifies the product identification information corresponding to the specific product on a basis of the first information and the second information.

### BRIEF DESCRIPTION OF THE DRAWINGS

FIG. 1 is a view depicting a general configuration of an ordering supporting system as an example of a component selection system to which a server apparatus according to an embodiment of the present invention is applied.

FIG. 2 is a view depicting an example of a relation between a product and components in the ordering supporting system.

FIG. 3 is a view depicting an example of a relation between a product model number and a component model number used in the ordering supporting system.

FIG. 4 is a view depicting an example of a mutual relation between web pages displayed on a terminal apparatus for specifying a component model number of a component a user wants to purchase.

FIG. 5 is a view depicting an example of a front page of FIG. 4.

FIG. 6 is a view depicting an example of a product search page of FIG. 4.

FIG. 7 is a view depicting an example of a product detail page of FIG. 4.

FIG. 8 is a view depicting an example of a component list page of FIG. 4.

FIG. 9 is a view depicting a manner in which part of a product model number is inputted on the front page.

FIG. 10 is a view depicting an example of a component list page displayed when part of a product model number is undefined.

FIG. 11 is a view depicting an example of a product detail page displayed when part of a product model number is undefined.

FIG. 12 is a view depicting an example of a general configuration of a control system of an ordering supporting server.

FIGS. 13A and 13B are views depicting examples of constituent component data.

FIG. 14 is a flow chart depicting an example of a procedure of an ordering supporting process executed by a control device of the ordering supporting server.

### DETAILED DESCRIPTION OF THE INVENTION

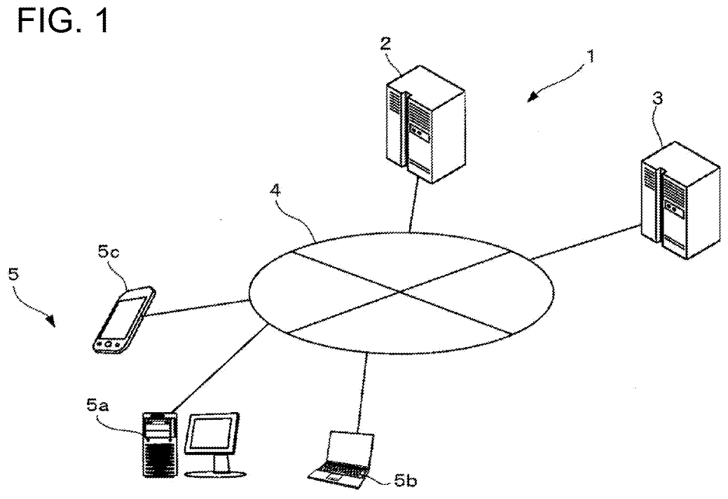

In the following, a server apparatus and so forth according to an embodiment of the present invention are described with reference to the accompanying drawings. FIG. 1 depicts an example in which the server apparatus according to the present embodiment is applied to an ordering supporting system constructed in order to allow a user to order at least one component configuring a predetermined product. The ordering supporting system 1 is configured as a network system or a client server system as an example of a component selection system to which the server apparatus according to the present invention is to be applied. However, the server apparatus of the present invention is applicable to various systems that include an element of allowing a user to select at least one component configuring a product, and the application target of it is not restricted to a system constructed assuming ordering of a component. For example, the server apparatus of the present invention may be applied to a system constructed so as to be suitable for such a use as confirmation of details or the like of a component by a user. A product targeted by the ordering supporting system 1 of FIG. 1 may be an article for a suitable use, as long as the article is configured by combination of a plurality of components. The product may be a finished product that itself implements one cohesive function or may be an assembly such as a module or a unit that demonstrates functions when it is incorporated in a finished product.

As depicted in FIG. 1, the ordering supporting system 1 includes an ordering supporting server 2, an order reception processing server 3, and a terminal apparatus 5 as a client connected for communication to the servers 2 and 3 through a network 4. The terminal apparatus 5 may include various devices that can be connected to a network, such as a PC (abbreviation of personal computer) 5a of the stationary type, a PC 5b of the notebook type, and a portable terminal 5c such as a smartphone.

The ordering supporting server 2 guides a user to various procedures necessary for the user to order a component configuring a product, through the terminal apparatus 5. Consequently, the ordering supporting server 2 functions as an example of the server apparatus according to the present invention. As an example, the ordering supporting server 2 is configured as a web server that causes various web pages to be displayed on the terminal apparatus 5 in response to an access from the terminal apparatus 5. The order reception processing server 3 is responsible for such processes as arrangement and delivery of a component ordered by the user and billing for the purchase price in response to an order determined by the ordering supporting server 2. Processes by the order reception processing server 3 may be similar to those of various known order reception processing servers and detailed description thereof is omitted.

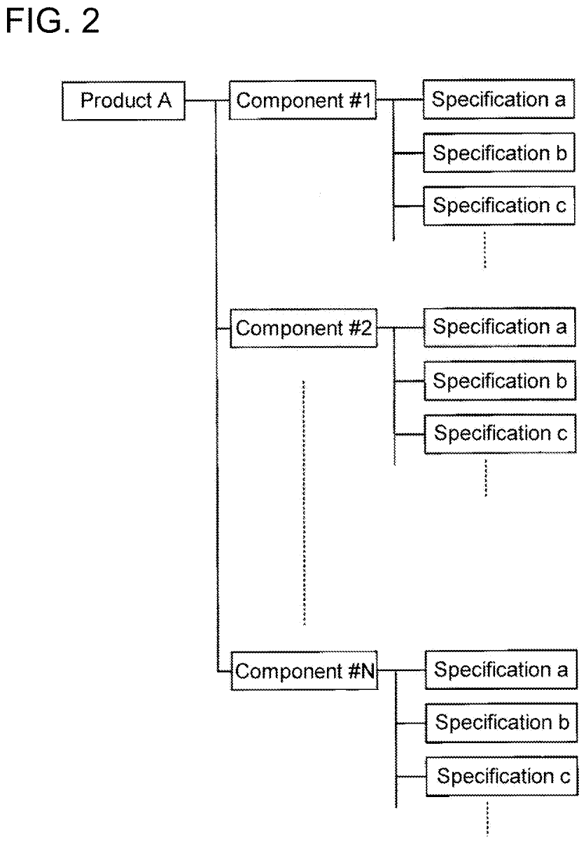

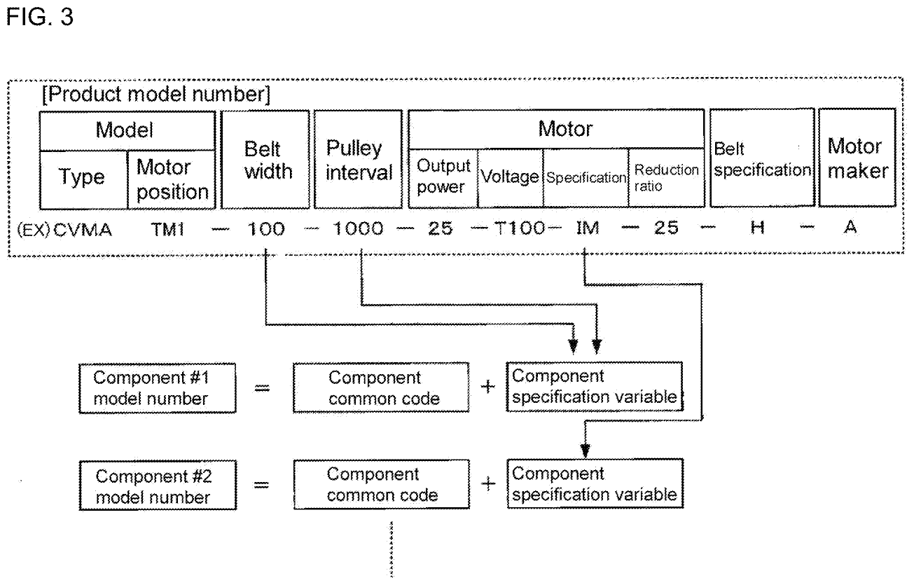

In the ordering supporting system 1, products and components are individually managed by model numbers. In the following, an example of management of products and components by model numbers is described with reference to FIGS. 2 and 3. First, an example of a relation between products and components in the ordering supporting system 1 is described with reference to FIG. 2. In the example depicted, a product A is configured by a combination of a plurality of components. The components can be classified into component classes in each of which the components are same in configuration except differences in specifications. In the example of FIG. 2, the number of classes of components is N, and numbers #1, #2, . . . , #N are assigned to the respective classes to distinguish the component classes from each other. In the following description, a component of the class #1 is represented as a component #1, and components of the class #2 and so forth may also be represented similarly.

A plurality of components that are different in specifications from each other are further prepared for one class. In the example of FIG. 2, differences in specifications are represented by assigning a, b, c, . . . to the specifications. Accordingly, each component configuring the product A is uniquely identified by specifying the class and the specification of the component. Though not depicted in FIG. 2, even in regard to a product other than the product A, similarly, a component exists which cannot be uniquely identified unless a particular specification is decided. However, the number of specifications for each class is suitably set. A component group that configures one product may include components whose specifications are the same, in other words, components between which no difference in specifications exists.

In order to uniquely identify each of products and a plurality of components configuring the products, in the ordering supporting system 1, product model numbers and component model numbers are set to manage the products and the components, for example, as depicted in FIG. 3. It is to be noted that, in FIG. 3, as an example of a product, a belt conveyor is supposed. The product model number corresponds to an example of product identification information set uniquely to each product, and the component model number corresponds to an example of component identification information set uniquely to each component.

In the example in FIG. 3, the product model number is configured by combining pieces of information that designate a model of the product, a belt width, a pulley interval, a motor, a belt specification, and a motor maker such that they are lined up with hyphens interposed therebetween. The information that designates a model of the product is set in a further classified manner into information that designates a type of the product and information that designates a motor position. For example, when the type of the product is set to “CVMA” and the motor position is set to “TM1,” the model of the belt conveyor is set as “CVMATM1.”

The information that designates the belt width indicates a width of a belt used for the belt conveyor, and for example, for a belt of 100 mm in width, the value of “100” is set. The information that designates the pulley interval indicates the distance between centers of a pair of pulleys to be bridged by a belt, and for example, if the distance between the centers is 1000 mm, then the value of “1000” is set. The information that designates the motor is in a further classified manner into output power, a voltage, specification, and a reduction ratio of an electric motor to be used as a driving source for the conveyor. For example, in the case of a motor whose output power is 25 watts, whose voltage is 100 V of three-phase alternating current, whose specification is of an induction motor, and whose gear head reduction ratio is 25, the value of the information that designates the motor is set to “25-T100-IM-25.” As the information indicative of the belt specification, at least one alphanumeric character set uniquely, for example, according to a shape of the belt, is set. For example, the value of the belt specification is set like “H.” As the information that designates the motor maker, at least one alphanumeric character uniquely set according to a business operator who provides the motor (manufacturer, distributor, or the like). For example, the value of the motor maker is set like “A.”

Of the product model number described hereinabove, the part for the model functions as an example of a product common part that is set in common to products that are same in configuration except differences in specifications. For example, the model specified as “CVMATM1” is set in common to a plurality of belt conveyors that are same in configuration irrespective of differences of specifications such as the belt width. On the other hand, to the information other than the model, that is, to the information designating the belt width, the pulley interval, the motor, the belt specification, and the motor maker, different values are set depending upon specifications of portions of the belt conveyor such as the belt, the pulley, and the motor, as understood from the description hereinabove. Consequently, the information of the belt width, the pulley interval, the motor, the belt specification, and the motor maker functions as an example of a product variable part. In short, even if the model of a belt conveyor is identified by “CVMATM1,” when the specifications of portions are different, the value of the variable part corresponding to the belt width or the like differs. Therefore, even if the model is the same, the product model numbers differ from each other depending upon the specifications of the products.

On the other hand, the component model number is set by combining a component common code set in common to components that are same in configuration except differences of the specifications and a component specification variable set to different values depending upon the specifications. For example, the component model number of each of a plurality of components to be classified into the component #1 depicted in FIG. 2 is set by combining a component common code set in common to the class #1 and a component specification variable set to different values depending upon the specifications a, b, c, . . . included in the class #1. Consequently, using the component model number as a clue, it is possible to uniquely identify a component of one of the specifications from among the components classified into the component #1. Also, for the components of the class #2 and so forth, a component model number is similarly set such that one of the components can be identified based on a combination of a component common code and a component specification variable.

In regard to the product model number, a range of products to which a same model is to be set is a range of products that are same in configuration except differences of the specifications. A criterion for the decision of whether or not configurations are the same may be set from such a point of view as, for example, commonality of constituent components or commonality in basic design. In short, a range within which a same model is set may be set according to the convenience of management of products. This similarly applies also to a range of components to which a same common code is to be set in the component model number. In particular, the range of components to which a same common code is to be set is a range of components that are same in configuration except differences of the specifications. A criterion for the decision of whether or not the configurations are the same may be set from such a point of view as, for example, commonality in function, use, or position of components. In short, a range within which a same common code is set may be set according to the convenience of management of components.

Between the variable part of the product model number and the component specification variable of the component model number, an associated relation is set according to a predetermined rule. For example, the width and the length of a belt configuring a belt conveyor are variables whose values are to be determined according to the belt width and the pulley interval in belt conveyor products. Further, for example, a frame component of a belt conveyor is a variable whose value in shape or dimension is to be determined according to specifications or the like of the belt width, the pulley interval, or the motor. In this manner, the value of a specification variable of a component depends upon the specification of each portion of a product. Therefore, if the specification of each portion of a product is determined, then the value of a specification variable of a component can uniquely be determined. The associated relation between the specifications of a product and the specification variables of components can be regularized (or standardized) in advance at the stage of designing the product. Accordingly, the product model number is set such that information that designates specifications of the product and is necessary to determine the values of specification variables of a plurality of components configuring the product is described in a predetermined order. Further, also the associated relation between the values of various specifications included in the product model number and the specification variables of the components is regularized in advance, and the information indicative of the rule is provided to the ordering supporting server 2 in advance.

The rule indicative of the associated relation may be set such that it determines, as minimal conditions, with the specification variable of the model number of which component the variable at each position of the product model number is associated and in what manner a value is to be converted between variables having an associated relation with each other. For example, in FIG. 3, the belt width and the pulley interval of the product model number and the specification variable of the model number of the component #1 are associated with each other, and besides, it is regularized in what manner specific values of the belt width and the belt interval are to be converted into a value of the specification variable of the component #1. Accordingly, if the value of the information that designates each of the belt width and the pulley interval of the product model number is referred to, then it is possible to determine the value of the specification variable included in the component model number of the component #1 and to thereby uniquely identify the component model number of the component #1. As regards the component #2, for example, an associated relation between the specification of the motor and the component specification variable is regularized. However, FIG. 3 merely depicts one example, and the associated relation between the variable part of the product model number and the variable part of the component model number may suitably be set according to the actual design of a product.

It is not necessarily required that the component model number be set so as to normally include the variable part. A component whose component model number is uniquely identified when the model part of the product model number is determined may exist. For example, a component group configuring a product may sometimes include components of a single specification between which no difference in specifications exists as described hereinabove. To such components, a single component model number may be set. In short, it is sufficient if a variable part that is to change according to the variable part of the product model number exists in regard to component model numbers of at least some of the components. Further, a component whose component model number is to be uniquely identified irrespective of the product model number may exist in a component group. Furthermore, a component whose component model number includes a specification variable that is to be uniquely determined by referring not only to the variable part of the product model number but also to the model part may exist.

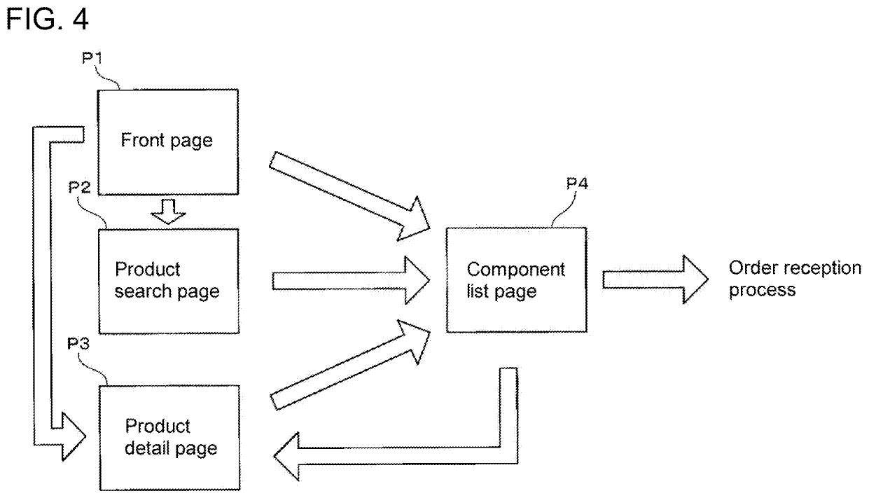

As described hereinabove, in the ordering supporting system 1, if a product model number is identified including a value of the variable part thereof, then it is possible to identify, using the product model number as a clue, respective component model numbers of a plurality of components configuring the product and present the identified component model numbers to the user, to thereby allow the user to select a component and a quantity of the component the user wants to purchase. The ordering supporting server 2 identifies the product model number of the product (that is an example of a specific product) in which the component the user wants to purchase is incorporated and causes the terminal apparatus 5 to display various web pages in order to allow the user to identify the component model number of the component the user wants to purchase, using the identified product model number as a clue. In the following, an example of a web page to be displayed on the terminal apparatus 5 by the ordering supporting server 2 in order to identify a component model number is described with reference to FIGS. 4 to 11.

FIG. 4 depicts an example of a mutual relation of web pages to be displayed on the terminal apparatus 5 by the ordering supporting server 2. In the example depicted, when a user suitably performs, using such a plurality of web pages as a predetermined front page P1, a predetermined product search page P2, and a predetermined product detail page P3 as an entrance, such an operation as to follow a link from the web pages P1 to P3, the user is guided to a component list page P4. The product search page P2 and the product detail page P3 may be called suitably from the front page P1.

On the component list page P4, components configuring a product are displayed in a list. If the user selects in the list a component and a quantity of the component the user wants to purchase, then an order of the component is issued, and the order reception processing server 3 processes order reception according to contents of the order. However, in a case where at least part of the specifications of the product is in an undefined state at the stage at which the component list page P4 is displayed, the user is re-guided to the product detail page P3. If the user defines the undefined part of the specifications on the re-guided product detail page P3, then a list of all components is displayed on the component list page P4. It is to be noted that the relation in FIG. 4 is a mere example, and the relation between web pages for guiding the user to the component list page P4 can be changed suitably as long as the component list page P4 is called in response to an input of at least part of a product model number. Further, such a configuration may be applied that the display transitions from the component list page P4 to a component detail page such that the user can order a component from the component detail page. The component detail page may be configured, for example, as a web page that indicates component details similarly to the product detail page P3 that indicates product details.

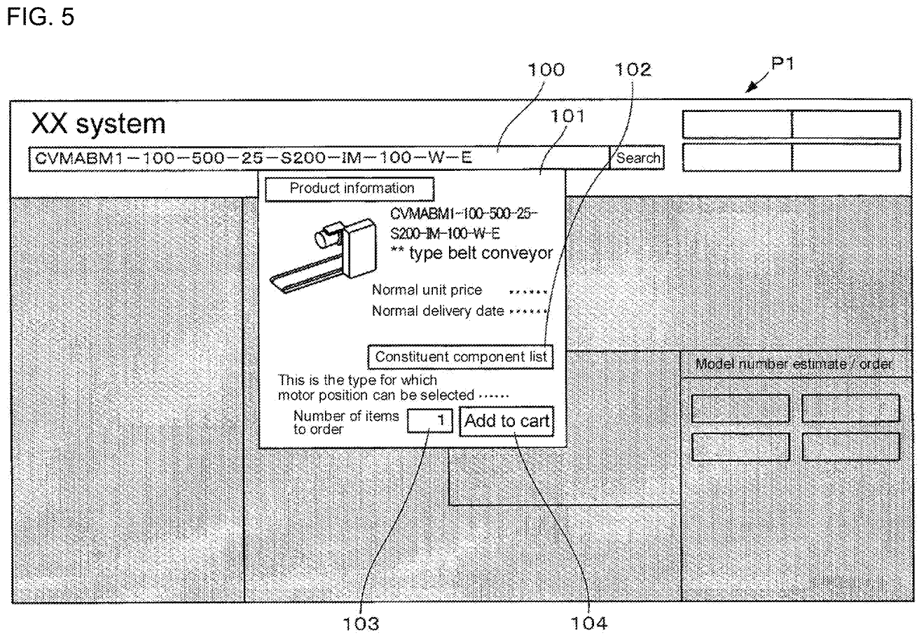

Examples of the web pages P1 to P4 described above are depicted in FIGS. 5 to 8. FIG. 5 depicts an example of the front page P1. On the front page P1 in FIG. 5, a search box 100 is provided. If the user inputs, in the search box 100, a product model number in a state in which all information of it is defined, then a suggest window 101 is displayed in such a manner as to be continuous from the search box 100. In the suggest window 101, such product information as an image and a name of a product corresponding to the product model number inputted by the user is displayed, and a list selection button 102 for selecting list display of constituent components is displayed. If the user clicks the list selection button 102, then the component list page P4 that indicates the components associated with the product model number in a list is displayed. It is to be noted that, although a quantity designation box 103 and an ordering button 104 for purchasing the product itself corresponding to the product model number are also displayed, they are not used for purchase of a component. Calling of the product search page P2 or the product detail page P3 from the front page P1 is performed by selectively operating a suitable choice prepared on the front page P1.

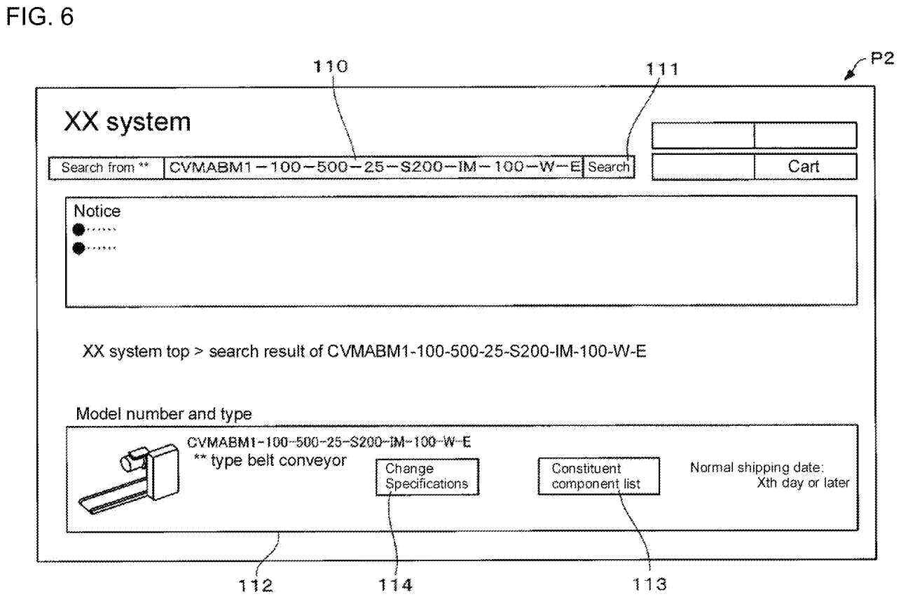

FIG. 6 depicts an example of the product search page P2. On the product search page P2 of FIG. 6, a search box 110 is displayed. If the user inputs a product model number in the search box 110 and operates a search button 111, then such product information as an image, a name, and so forth of the searched product is displayed in a result displaying portion 112, and a list selection button 113 for selecting list display of constituent components is displayed. If the user clicks the button 113, then the component list page P4 that indicates components associated with the product model number in a list is displayed.

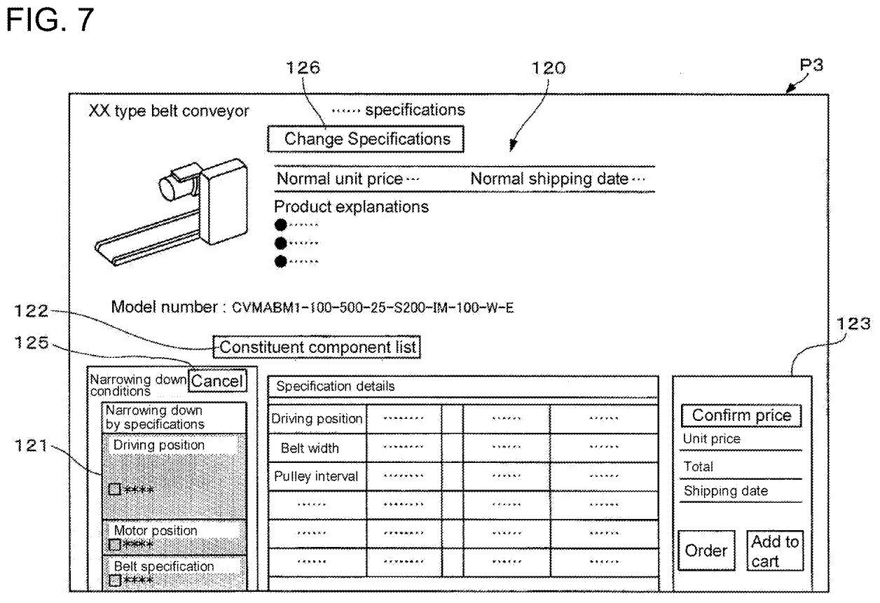

FIG. 7 depicts an example of the product detail page P3. On the product detail page P3 of FIG. 7, a product detail displaying portion 120 that indicates details including an image, explanation, specifications, dimensions, and so forth of the product and a specification designation portion 121 for allowing the user to designate specifications of portions of the product. FIG. 7 depicts the product detail page P3 that is displayed in a case in which all information of the product model number is defined, and the specification designation portion 121 is displayed in a state in which an operation for designating specifications is disabled and is displayed in a gray-out state. A list selection button 122 is displayed also on the product detail page P3. If the user clicks the list selection button 122, then the component list page P4 that indicates components associated with the product model number in a list is displayed. It is to be noted that, although a purchase operation portion 123 for purchasing the product itself corresponding to the product model number is included also in the product detail page P3, this is not used for purchase of a component.

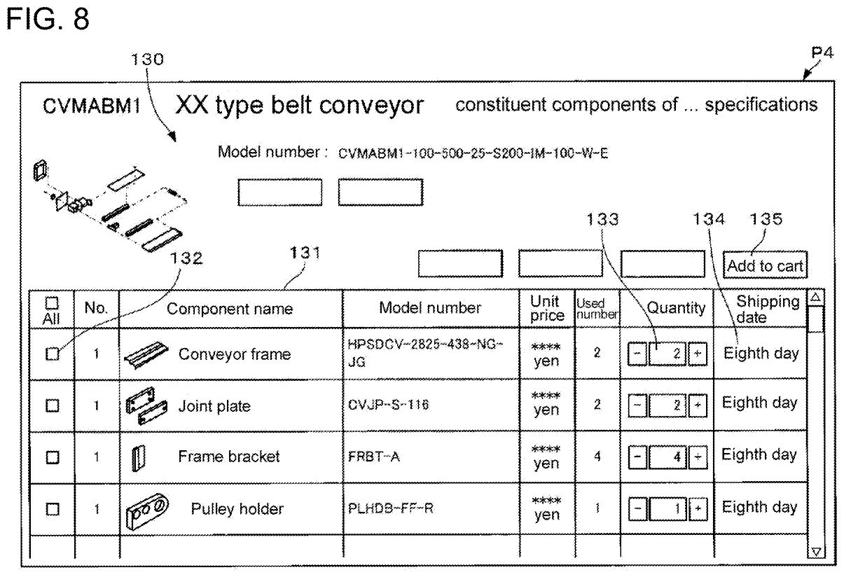

FIG. 8 depicts an example of the component list page P4. On the component list page P4 of FIG. 8, an information displaying portion 130 for indicating an exploded perspective view, a model number, and so forth of a product and a list displaying portion 131 in which information of various components specified on the basis of a product model number is displayed in the form of a list are provided. In the list displaying portion 131, as an example, a number assigned to a component (that corresponds to a component number in the exploded perspective view depicted in the information displaying portion 130) and a name, a component model number, a unit price, and a used quantity (quantity of a component used in one product) of the component are displayed. Further, in the list displaying portion 131, a check box 132 for allowing the user to designate a purchase target, a quantity designation portion 133 for allowing the user to designate a purchase quantity, and shipping date information 134 indicative of rough estimation for a shipping date are also displayed. If the user checks the check box 132 of a component the user wants to purchase, designates a purchase quantity in the quantity designation portion 133, and clicks an ordering instruction button 135, then contents of the order are determined using the operation as a trigger, and information indicative of the contents of the order is passed to the order reception processing server 3 and an order reception process of the component is started by the order reception processing server 3. It is to be noted that the order reception process of a product or a component may be started through such a plurality of steps that it is started on condition that a page for confirming the contents of the order is displayed on the terminal apparatus 5 in response to an operation of the ordering instruction button 135 and the user performs an operation for determining the order.

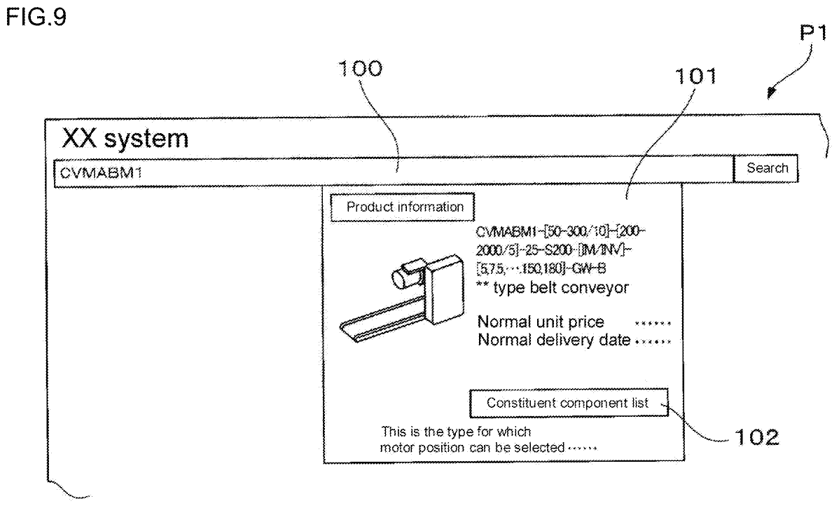

Although it is described that, in the example in FIG. 5, a product model number is inputted in the search box 100 in a state in which all information thereof is defined, it is also possible to input only part of a product model number, for example, as depicted in FIG. 9. FIG. 9 depicts a state in which, of the product model number, “CVMABM1” that is information designating a model is inputted. In this case, in the suggest window 101, the product model number corresponding to the model “CVMABM1” is displayed in a state in which the variable part thereof is undefined. For example, information corresponding to the belt width is displayed as [50−300/10]. This display signifies that the belt width can be designated in a unit of 10 mm within the range from 50 to 300 mm. Also in regard to the other variable parts, choices for them are displayed in a suitable manner. It is to be noted that, also in the product search page P2 or the product detail page P3, it is possible to input only part of a product model number to call the component list page P4.

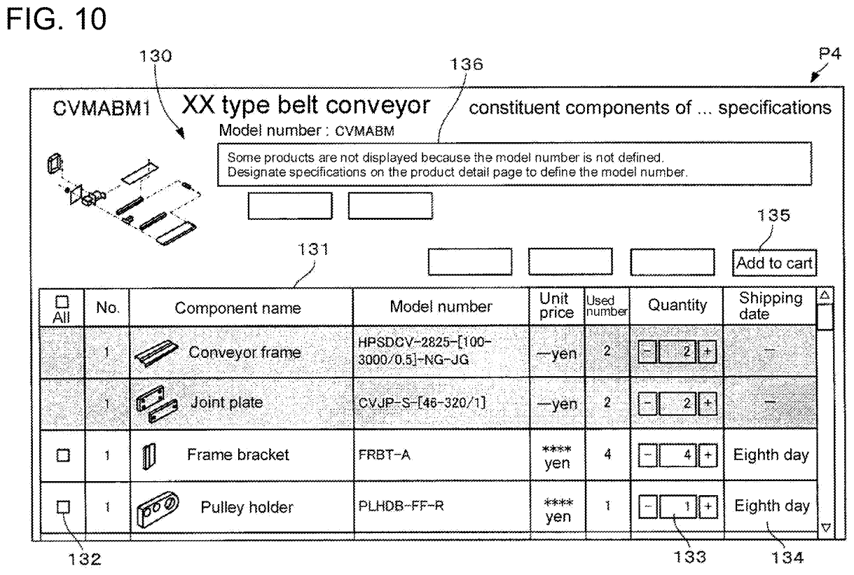

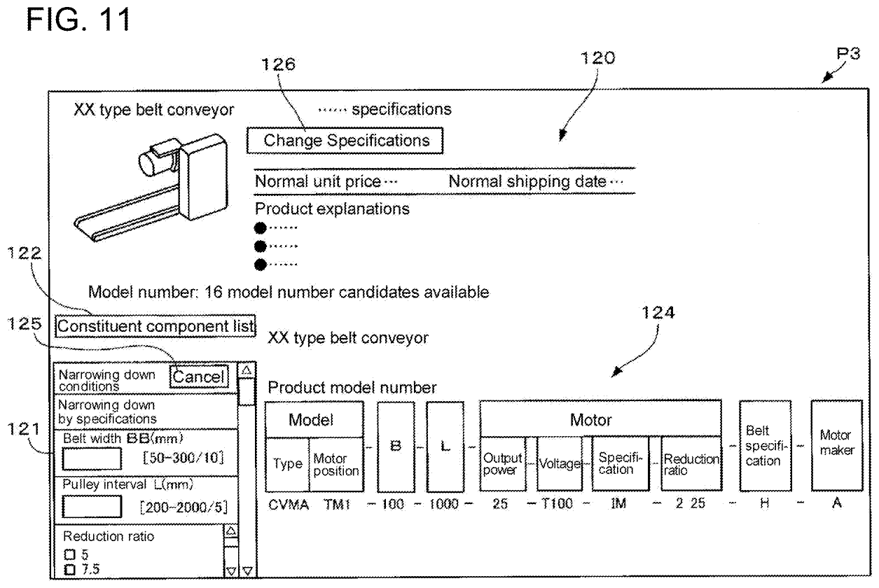

FIG. 10 depicts an example of display of the component list page P4 of the case in which part of a product model number is not defined. In the example in FIG. 10, since some of the variable parts of the product model number are undefined, an aluminum frame for a conveyor and a joint plate for a conveyor from among components displayed in the list displaying portion 131 are displayed in a state in which part of the component model number is undefined. The component including such an undefined portion is grayed out, inputting operations for the check box 132 and the quantity designation portion 133 are disabled, and the unit price and the shipping date are not displayed. In the information displaying portion 130, a message 136 notifying that the model number is undefined and some of the components are not displayed, and prompting the user to move to the product detail page P3 to select specifications for the undefined portions is also displayed. An example of the product detail page P3 displayed when part of the product model number is undefined in this manner is depicted in FIG. 11. It is to be noted that the transition from the component list page P4 to the product detail page P3 may be implemented, for example, by setting a suitable link portion for transition on the component list page P4 or by a returning operation of a browser for viewing the web page.

In the product detail page P3 depicted in FIG. 11, the specification designation portion 121 is changed to a state in which an inputting operation is possible, as apparent from the comparison to the display example in FIG. 7. Further, in the product detail displaying portion 120, a product model number displaying portion 124 is additionally displayed. In the product model number displaying portion 124, information indicating that the configuration of the product model number is classified in such a manner as exemplified in FIG. 3 is displayed. The user can specifically designate a value of a variable of the undefined product model number by referring to the display of the product model number displaying portion 124 and inputting a value for a variable such as the belt width from the specification designation portion 121. If the list selection button 122 is operated after values for all undefined variables are specified, then the component list page P4 is displayed in a state in which all information of the product model number is defined as depicted in FIG. 8.

As exemplified in FIGS. 5 to 7, in a case in which the user inputs a product model number in a state in which all information thereof is defined, the component model numbers of all components are displayed in a defined state on the component list page P4 as exemplified in FIG. 8. The user may sometimes desire to switch, from the state in which the component model numbers of all components are defined in this manner, at least part of the specifications of the product to an undefined state and change part of the product specifications. In preparation for such desire, for example, a specification change button 114 is provided on the product search page P2 of FIG. 6, and a setting cancel button 125 is displayed in the specification designation portion 121 of the product detail page P3 of FIG. 7. Furthermore, a specification change button 126 is provided also in the product detail displaying portion 120 of the product detail page P3. If the user operates the button 114, 125, or 126, then the variable part of the product model number is changed into an undefined state, and together with this, the product detail page P3 of the state depicted in FIG. 11 is displayed. By inputting a suitable value to the specification designation portion 121 of the product detail page P3, the user can change the product model number to a state in which at least part of the specifications is changed and cause components associated with the specifications after the change to be displayed on the component list page P4.

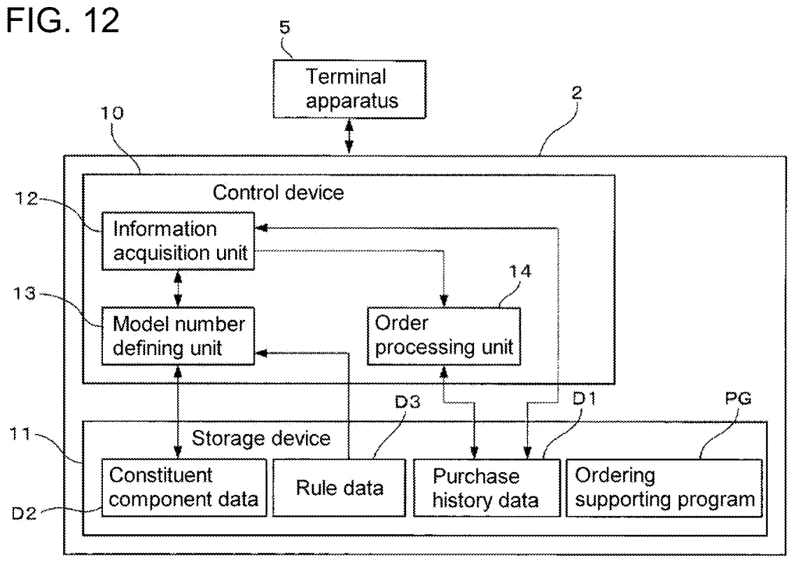

Now, a specific configuration example of the ordering supporting server 2 is described with reference to FIGS. 12 to 14. FIG. 12 depicts an example of a general configuration of a control system of the ordering supporting server 2. The ordering supporting server 2 includes a control device 10 and a storage device 11. The control device 10 is configured as a computer unit that includes in combination a microprocessor, and peripheral devices necessary for operation of the microprocessor such as an internal storage device. The storage device 11 functions as an external storage device for the control device 10 by storing various kinds of information by utilizing a nonvolatile storage medium such as a magnetic storage medium or a flash memory. However, the storage device 11 is not limited to an example provided as part of the ordering supporting server 2 but may otherwise be provided as a database server that cooperates with the ordering supporting server 2.

The storage device 11 has recorded therein an ordering supporting program PG as a computer program for causing the control device 10 to execute various processes necessary for ordering of a product or a component. By the control device 10 reading in and executing the ordering supporting program PG, an information acquisition unit 12, a model number defining unit 13, and an order processing unit 14 are provided as logical devices implemented by a combination of computer hardware and software in the control device 10. The information acquisition unit 12 acquires information necessary to specify a product model number from the terminal apparatus 5. The information acquisition unit 12 may acquire information separately as information in which the value of at least some variable of a product model number is in an undefined state and information for defining the undefined value as described hereinabove, for example, with reference to FIGS. 4 to 11.

Also it is possible for the information acquisition unit 12 to acquire a product model number by referring to purchase history data D1 recorded in the storage device 11. In the purchase history data D1, purchase histories of products or components purchased in the past by users who have accessed the ordering supporting server 2 are recorded in an associated relation with identification information of the users. For example, a serial number and a product model number or a component model number of each of products or components purchased by each user are recorded in an associated relation with identification information of the user in the purchase history data D1. Accordingly, the information acquisition unit 12 can authenticate a user who has accessed the ordering supporting server 2 from a terminal apparatus 5 to decide the identification information of the user, acquire a serial number of a product or the like from the terminal apparatus 5, and then acquire model numbers of products or components purchased in the past by the user while referring to the user identification information and the serial number.

The model number defining unit 13 decides on the basis of the information acquired by the information acquisition unit 12 whether or not all information of the product model number is defined and requests, if a variable whose value is undefined is left, the information acquisition unit 12 to acquire information for defining the undefined variable. In this case, the information acquisition unit 12 acquires, for example, an input to the specification designation portion 121 of FIG. 11 and provides the input to the model number defining unit 13. The model number defining unit 13 refers to the product model number in which all information is defined and constituent component data D2 and rule data D3 retained in the storage device 11 to define the component model numbers of all components associated with the product model number. The order processing unit 14 acquires order contents of a product or a component by the user from the terminal apparatus 5 and provides the acquired order contents to the order reception processing server 3 to cause the order reception processing server 3 to start an order reception process.

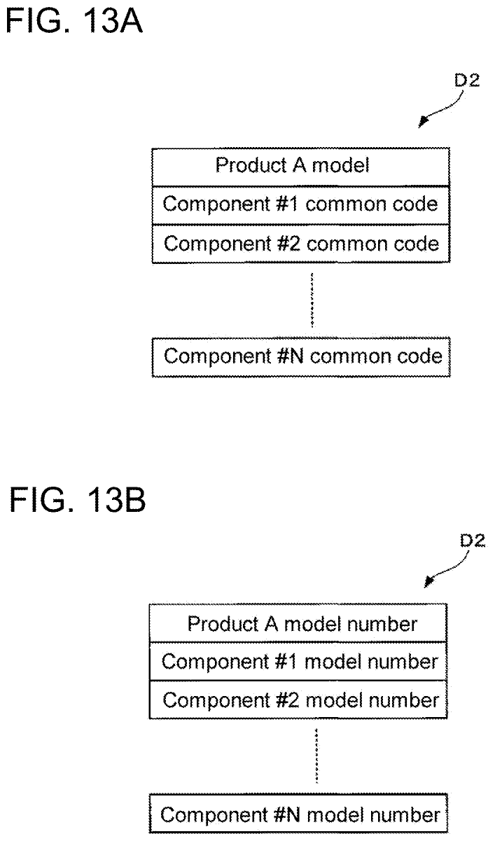

The constituent component data D2 recorded in the storage device 11 is data that describes associated relations between products and all components configuring the products by using at least a model of product model numbers and at least a common code of component model numbers. For example, describing taking the product A of FIG. 2 as an example, the constituent component data D2 is configured by describing the model part of the product model number of the product A and the common code of component model numbers of all components (components of the classes #1 to #N) configuring the product A in an associated relation with each other as depicted in FIG. 13A. Alternatively, as depicted in FIG. 13B, the constituent component data D2 may be configured by describing the product model number of the product A and the component model numbers of all components configuring the product A in an associated relation with each other. The rule data D3 is data that describes a rule for associated relations set between product model numbers and component model numbers.

If a model that is a common part of product model numbers can be identified by referring to the constituent component data D2, then the common code of all components included in products of the model can be specified. The model of a product model number is specified by the information acquisition unit 12 on the basis of information acquired from the terminal apparatus 5, and also the value of a variable part of the product model number is specified on the basis of the information acquired from the terminal apparatus 5 by the information acquisition unit 12. Consequently, the model number defining unit 13 can acquire a product model number in a state in which all information thereof is defined, according to information provided from the information acquisition unit 12. Further, the value of a specification variable of a component model number can uniquely be specified from a product model number according to a rule that defines associated relations between product model numbers and component model numbers. Accordingly, the model number defining unit 13 can acquire a product model number from the information acquisition unit 12 and define the component model numbers of all components associated with the product model number on the basis of the constituent component data D2 and the rule data D3.

Although the control device 10 includes a logical device for controlling switching and so forth of display of a web page according to an operation of the terminal apparatus 5 and other devices in addition to the logical devices depicted in FIG. 12, illustration of them is omitted. Further, although the storage device 11 has stored therein various kinds of data such as image data necessary to display a web page, or product data or component data that describes names, features, and so forth of products or components, illustration of them is also omitted.

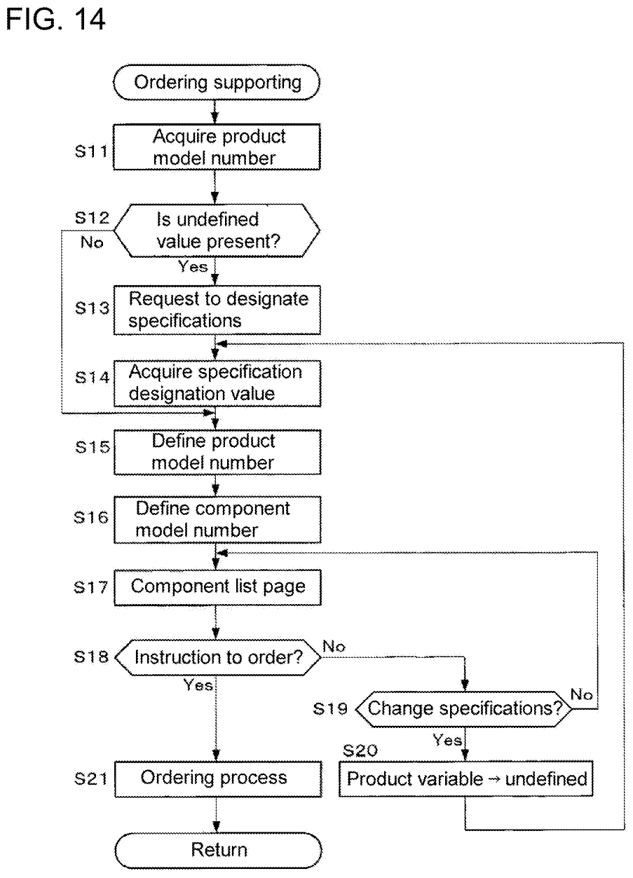

Now, an example of an ordering supporting process executed by the control device 10 to define contents of an order of a component by a user is described with reference to FIG. 14. The ordering supporting process depicted is started using it as a trigger that, for example, the user accesses the ordering supporting server 2 and inputs at least part of a product model number in a web page. After the ordering supporting process is started, the information acquisition unit 12 of the control device 10 acquires information inputted to the terminal apparatus 5 in order to designate a product model number by the user and provides the acquired information to the model number defining unit 13 (step S11). In this case, it is sufficient if the product model number inputted to the terminal apparatus 5 includes at least the part of the model, and some variable parts may be undefined in value. In a case in which a product model number is inputted in a state in which some variables are undefined, the inputted information corresponds to an example of first information. To the terminal apparatus 5, a serial number of a product on which the component the user wants to purchase is to be mounted may be inputted. In this case, the information acquisition unit 12 specifies a product model number corresponding to the serial number on the basis of the purchase history data D1 and supplies the specified product model number to the model number defining unit 13.

The model number defining unit 13 decides whether or not an undefined value is included in the product model number supplied from the information acquisition unit 12 (step S12). When an undefined value is included, the model number defining unit 13 issues a request to the information acquisition unit 12 to allow the user to select the undefined value, and in response to the request, the information acquisition unit 12 causes the terminal apparatus 5 to display the component list page P4 (as an example, FIG. 10) of the case where an undefined component model number exists and request the user to designate specifications of the product (step S13). It is to be noted that the display of the component list page P4 may be performed through an operation of the user or may be switched automatically by the control device 10. The user requested to designate specifications can designate specifications of the product by using the specification designation portion 121 of the product detail page P3 (as an example, FIG. 11). The display of the product detail page P3 may be performed through an operation of the user or may be switched automatically by the control device 10. Further, as exemplified in FIGS. 9 to 11, in a case where at least some value in the product model number is in an undefined state, when a range within which the value can be designated is to be displayed on the terminal apparatus 5, the model number defining unit 13 may suitably refer to the constituent component data D2 and the rule data D3 to decide the range for the undefined value and provide the decided information to the information acquisition unit 12, so that it is reflected on the component list page P4 or the like.

After the user designates specifications of the product, then the information acquisition unit 12 acquires the value designating the specifications from the terminal apparatus 5 and provides the acquired value to the model number defining unit 13 (step S14). The information acquired at this stage corresponds to an example of second information. The model number defining unit 13 defines the product model number according to the information acquired at steps S11 and S14 (step S15) and defines component model numbers associated with the acquired product model number (step S16). In this case, the model number defining unit 13 first refers to the constituent component data D2 to specify a common code of all component model numbers associated at least with the model of the product model number and converts various values included in the product model number into values of the specification variables of the component model numbers according to the rule data D3 to define the values of the specification variables of all component model numbers associated with the product model number. It is to be noted that, in a case where it is decided at step S12 that no undefined value is included, the processes at steps S13 and S14 are skipped and the processing is advanced to step S15. In this case, since information sufficient to define the product model number has been provided to the model number defining unit 13 at step S11, it is sufficient if the model number defining unit 13 defines the product model number according to the information at step S15.

After the component model numbers are defined by the model number defining unit 13, the defined information is provided to the information acquisition unit 12. The information acquisition unit 12 causes the terminal apparatus 5 to display the component list page P4 (as an example, FIG. 8) of the case where all information is defined (step S17). Thereafter, the information acquisition unit 12 decides whether or not the user has issued an instruction to order a component (step S18). For example, when the ordering instruction button 135 of FIG. 8 is operated, it may be decided that an instruction to order has been issued.

When it is decided at step S18 that an instruction to order has not been issued, the information acquisition unit 12 decides whether or not the user has issued an instruction to change the product specifications (step S19). For example, when the specification change button 114 of the product search page P2 of FIG. 6 or the setting cancel button 125 of the product detail page P3 of FIG. 7 is operated, the information acquisition unit 12 may decide that an instruction to change the specifications has been issued. When an instruction to change the specifications has not been issued, the information acquisition unit 12 returns the processing to the process of FIG. 16. On the other hand, when it is decided at step S19 that an instruction to change the specifications has been issued, then the information acquisition unit 12 changes the values of variables of the product model number having been defined by the processes so far into an undefined state (step S20), and thereafter, the information acquisition unit 12 returns the processing to the process at step S14. Consequently, the component list page P4 is displayed in the manner of the case where an undefined value exists (as an example, FIG. 10), and similarly, the product detail page P3 is displayed in the manner of the case where an undefined value exists (as an example, FIG. 11). Accordingly, when it is designated to change the specifications, it is possible for the user to re-designate at least some variable of the product model number by utilizing the specification designation portion 121 of the product detail page P3. It is to be noted that, in the processes at steps S19 and S20, at least one variable the user wants to change from among various variables included in the variable part of the product model number may be designated by the user such that only the value of the designated variable is changed to an undefined state.

When it is decided at step S18 that the user has issued an instruction to order, the information acquisition unit 12 acquires contents of the order, namely, a component model number and a purchase quantity of the component the user wants to purchase, and provides the contents of the order to the order processing unit 14 (step S21). Receiving the contents of the order, the order processing unit 14 executes a process for defining the order and provides a result of the execution to the order reception processing server 3 to cause the order reception processing server 3 to start an order reception process. The processing of FIG. 14 is completed therewith.

It is to be noted that, although FIG. 14 omits a process of a case where an instruction to order a product is issued from the terminal apparatus 5, in regard to ordering of a product, it is sufficient, for example, if a product model number is specified by the processes at step S11 to S15 and the specified product model number and a purchase quantity are provided to the order processing unit 14, so that the order processing unit 14 executes an ordering process.

According to the embodiment described above, even if a user does not know a complete product model number of a product on which a component the user desires to purchase is mounted, if the user designates at least a model, then a list of components associated with the model is presented to the user, and if the user designates product specifications, then the user can recognize the component model number of the component the user wants to purchase. Further, even when the product specifications are defined, if the user instructs to change the specifications and designates the specifications to change to, then the user can find out the component model number of the component associated with the product after the change of the specifications. Accordingly, the flexibility or the degree of freedom in selection of a component is improved.

In the embodiment described above, the information acquisition unit 12 functions as an example of information acquisition means by executing the processes at steps S11 and S14 of FIG. 14, the model number defining unit 13 functions as an example of product identification information specification means by executing the process at step S15 of FIG. 14, the model number defining unit 13 functions as an example of component identification information specification means by executing the process at step S16 of FIG. 14, and the information acquisition unit 12 functions as an example of information provision means by executing the process at step S17 of FIG. 14. Further, the information acquisition unit 12 functions as an example of variable initializing means by executing the process at step S20 of FIG. 14.

The present invention is not limited to the embodiment described above and may be carried out in an embodiment in which various modifications or changes are made. For example, the logical device to be provided in the control device 10 of the ordering supporting server 2 is not limited to the information acquisition unit 12, the model number defining unit 13, and the order processing unit 14 exemplified in FIG. 12, and a suitable logical device may be provided as long as it can cause the control device 10 to function as the means described above according to the present invention.

Although, in the embodiment described above, a rule for defining the value of a specification variable of a component model number on the basis of a product variable part of a product model number is described in the rule data D3 and stored in the storage device 11, at least part of the rule may be described in the computer program PG in place of or in addition to the rule data D3.

The web page that is displayed in order to acquire information necessary for specifying a product model number from the terminal apparatus 5 is not limited to the forms exemplified in FIGS. 5 to 11, and a suitable web page may be displayed on the terminal apparatus 5.

Although, in the embodiment described above, a product model number can be inputted through the terminal apparatus 5 by the user at step S11 of FIG. 14 in a state in which at least some value of the variable part of the product model number is undefined, the present invention is not limited to such an embodiment as just described. For example, even if it is made essential that a product model number is inputted at step S11 to the terminal apparatus 5 in a state in which all information thereof is defined, since the processes at steps S19 and S20 of FIG. 14 are executed later, it is possible for the user to change part of the specifications of the product and find out the component model number of a component suitable for the product after the change. In short, an opportunity in which a product model number is inputted in a state in which at least some value of the variable part thereof is undefined may be set suitably.

Various forms of the present invention derived from each of the embodiment and the modifications described above are described below. It is to be noted that, although, in the following description, a corresponding component element depicted in the accompanying drawings is added in parentheses for facilitating understanding of the forms of the present invention, this does not restrict the present invention to the depicted embodiment.

A server apparatus (2) according to one aspect of the present invention is a server apparatus (2) for a component selection system. In the component selection system, for each of a plurality of products, product identification information (as an example, the product model number) unique to each product is set, the product identification information being a combination of a product common part (as an example, the model of FIG. 3) set in common to products that are same in configuration except differences of specifications, and a product variable part (as an example, the part other than the model of FIG. 3) set to different values depending upon the specifications. For each of a plurality of components configuring each product, component identification information (as an example, the component model number of FIG. 3) unique to each component is set, the component identification information being a combination of a component common part (as an example, the common code of FIG. 3) set in common to components that are same in configuration except differences of specifications, and a component variable part (as an example, the specification variable of FIG. 3) set to different values depending upon the specifications. The server apparatus (2) is applied to the component selection system (1) in which values of the product variable part of the product identification information and values of the component variable part of the component identification information are associated with each other according to a predetermined rule. The server apparatus (2) provides information for allowing a user to select at least one component configuring a specific product to a terminal apparatus (5) used by the user. The server apparatus (2) includes information acquisition means (12, S11, S14) for acquiring information for specifying the product identification information corresponding to the specific product from the terminal apparatus, product identification information specification means (13, S15) for specifying the product identification information corresponding to the specific product on a basis of the information acquired by the information acquisition means, component identification information specification means (13, S16) for specifying, on a basis of constituent component data (D2) that describes an associated relation between at least the product common part of the product identification information and at least the component common part of the component identification information, the component identification information associated with the product identification information specified by the product identification information specification means while defining a value of the component variable part associated with a value of the product variable part according to the predetermined rule, and information provision means (12, S17) for providing the component identification information specified by the component identification information specification means to the terminal apparatus. The information acquisition means acquires first information that designates the product identification information corresponding to the specific product in a state in which a value of at least part of variables of the product variable part is undefined and second information that designates a value of the variable in the undefined state, from the terminal apparatus. The product identification information specification means specifies the product identification information corresponding to the specific product on a basis of the first information and the second information.

An information provision method for a component selection system according to one aspect of the present invention is an information provision method for a component selection system in which, for each of a plurality of products, product identification information (as an example, the product model number) unique to each product is set, the product identification information being a combination of a product common part (as an example, the model of FIG. 3) set in common to products that are same in configuration except differences of specifications and a product variable part (as an example, the part other than the model of FIG. 3) set to different values depending upon the specifications, and for each of a plurality of components configuring each product, component identification information (as an example, the component model number of FIG. 3) unique to each component is set, the component identification information being a combination of a component common part (as an example, the common code of FIG. 3) set in common to components that are same in configuration except differences of specifications and a component variable part (as an example, the specification variable of FIG. 3) set to different values depending upon the specifications. The information provision method is applied to the component selection system (1) in which values of the product variable part of the product identification information and values of the component variable part of the component identification information are associated with each other according to a predetermined rule. Information for allowing a user to select at least one component configuring a specific product is provided from a server apparatus (2) to a terminal apparatus (5) used by the user. The information provision method causes a computer (10) of the server apparatus to execute an information acquisition step (S11, S14) of acquiring information for specifying the product identification information corresponding to the specific product from the terminal apparatus, a product identification information specification step (S15) of specifying the product identification information corresponding to the specific product on a basis of the information acquired by the information acquisition step, a component identification information specification step (S16) of specifying, on a basis of constituent component data (D2) that describes an associated relation between at least the product common part of the product identification information and at least the component common part of the component identification information, the component identification information associated with the product identification information specified by the product identification information specification step while defining a value of the component variable part associated with a value of the product variable part according to the predetermined rule, and an information provision step (S17) of providing the component identification information specified by the component identification information specification step to the terminal apparatus. At the information acquisition step, first information that designates the product identification information corresponding to the specific product in a state in which a value of at least part of variables of the product variable part is undefined and second information that designates a value of the variable in the undefined state are acquired from the terminal apparatus. At the product identification information specification step, the product identification information corresponding to the specific product is specified on a basis of the first information and the second information.

A computer program (PG) according to one aspect of the present invention is a computer program for a computer (10) of a server apparatus (2) provided in a component selection system (1). In the component selection system, for each of a plurality of products, product identification information (as an example, the product model number) unique to each product is set, the product identification information being a combination of a product common part (as an example, the model of FIG. 3) set in common to products that are same in configuration except differences of specifications, and a product variable part (as an example, the part other than the model of FIG. 3) set to different values depending upon the specifications. For each of a plurality of components configuring each product, component identification information (as an example, the component model number of FIG. 3) unique to each component is set, the component identification information being a combination of a component common part (as an example, the common code of FIG. 3) set in common to components that are same in configuration except differences of specifications, and a component variable part (as an example, the specification variable of FIG. 3) set to different values depending upon the specifications. Values of the product variable part of the product identification information and values of the component variable part of the component identification information are associated with each other according to a predetermined rule. The computer program causes the computer to function such that information necessary for allowing a user to select at least one component configuring a specific product is provided to a terminal apparatus used by the user. The computer program causes the computer to function as information acquisition means (12, S11, S14) for acquiring information for specifying the product identification information corresponding to the specific product from the terminal apparatus, product identification information specification means (13, S15) for specifying the product identification information corresponding to the specific product on a basis of the information acquired by the information acquisition means, component identification information specification means (13, S16) for specifying, on a basis of constituent component data (D2) that describes an associated relation between at least the product common part of the product identification information and at least the component common part of the component identification information, the component identification information associated with the product identification information specified by the product identification information specification means while defining a value of the component variable part associated with a value of the product variable part according to the predetermined rule, and information provision means (12, S17) for providing the component identification information specified by the component identification information specification means to the terminal apparatus. The information acquisition means acquires first information that designates the product identification information corresponding to the specific product in a state in which a value of at least part of variables of the product variable part is undefined and second information that designates a value of the variable in the undefined state, from the terminal apparatus. The product identification information specification means specifies the product identification information corresponding to the specific product on a basis of the first information and the second information.

According to the aspect described above, in a case where product identification information of a product is defined, component identification information of a component associated with the product identification information is not specified directly according to the associated relation described in a data table or the like, but the component identification information associated with the product identification information is specified while a value of the component variable part associated with a value of the product variable part of the product model number is defined according to a predetermined rule. Accordingly, it is possible to flexibly cope with a change of a component according to the specifications of the product, and the flexibility or the degree of freedom in component selection can be increased. Further, by acquiring the information necessary for specifying the product identification information separately for first information and second information from the terminal apparatus, for example, even if part of the specifications of the product is undefined, if the user is allowed to start component selection and further designate a suitable value in regard to the undefined specifications, then component identification information that is different depending upon the product specifications can be provided to the terminal apparatus. Consequently, for example, such an operation as to perform suitable narrowing down in regard to part of the specifications or to repeat examinations becomes possible, and the convenience to the user is improved.

It is to be noted that the computer program according to one aspect of the present invention may be provided in a state in which it is stored in a storage medium. If the storage medium is used, then by installing the computer program according to the present invention into a computer and executing the computer program by the computer, it is possible to utilize the computer to implement the server apparatus of the present invention. The storage medium in which the computer program is stored may be a non-transitory storage medium such as a compact disc read-only memory (CD-ROM).

The information acquisition means may execute a process (S11) of acquiring the first information from the terminal apparatus, a process (S13) of requesting the user through the terminal apparatus to designate a value of an undefined variable in the acquired first information, and a process (S14) of acquiring a value designated by the user in response to the request for designation of the value of the undefined variable, as the second information from the terminal apparatus. According to this configuration, in a case where part of the specifications of the product is undefined, designation of the specifications is requested to the user. If the user designates the specifications in response to the request, then the component identification information according to the designation is provided to the terminal apparatus.

In the aspect described above, the server apparatus may further include variable initializing means (12, S20) for changing a value of at least part of the variables of the product variable part included in the product identification information specified by the product identification information specification means from the defined state into an undefined state on a basis of an instruction from the user given through the terminal apparatus, and the information acquisition means may request the user through the terminal apparatus to designate a value of the variable changed into the undefined state by the variable initializing means and acquire a value designated by the user as the second information from the terminal apparatus. According to this configuration, even in a case where product identification information is defined once and the defined product identification information is provided to the terminal apparatus, it is possible for the user to change part of the specifications later and recognize component identification information according to the specifications after the change through the terminal apparatus. Consequently, the user can select a component according to the product specifications comparatively easily.

The component selection system may be configured as an ordering supporting system for allowing the user to order at least one component, and component identification information provided by the information provision means may be used as information for selecting a component the user desires to purchase. According to this configuration, the flexibility and the degree of freedom in component selection obtained by the server apparatus of the present invention can be demonstrated upon ordering of a component to increase the convenience at the time when the user orders a component.

This application is based upon and claims the benefit of priority of the prior Japanese Patent Application No. 2018-248382, filed on Dec. 28, 2018, the entire contents of which are incorporated herein by reference.

### REFERENCE SIGNS LIST

1: Ordering supporting system
2: Ordering supporting server
3: Order reception processing server
5: Terminal apparatus
10: Control device
12: Information acquisition unit
13: Model number defining unit
14: Order processing unit

1. A server apparatus for a component selection system in which,
for each of a plurality of products, product identification information unique to each product is set, the product identification information being a combination of a product common part set in common to products that are same in configuration except differences of specifications, and a product variable part set to different values depending upon the specifications, and
for each of a plurality of components configuring each product, component identification information unique to each component is set, the component identification information being a combination of a component common part set in common to components that are same in configuration except differences of specifications, and a component variable part set to different values depending upon the specifications,
the server apparatus being applied to the component selection system in which values of the product variable part of the product identification information and values of the component variable part of the component identification information are associated with each other according to a predetermined rule,
the server apparatus providing information for allowing a user to select at least one component configuring a specific product to a terminal apparatus used by the user,
the server apparatus comprising:
a microprocessor, wherein
the microprocessor is configured to acquire information for specifying the product identification information corresponding to the specific product from the terminal apparatus,
the microprocessor is configured to specify the product identification information corresponding to the specific product on a basis of the information acquired by the information acquisition means,
the microprocessor is configured to specify, on a basis of constituent component data that describes an associated relation between at least the product common part of the product identification information and at least the component common part of the component identification information, the component identification information associated with the product identification information specified by the product identification information specification means while defining a value of the component variable part associated with a value of the product variable part according to the predetermined rule,
the microprocessor is configured to provide the component identification information specified by the component identification information specification means to the terminal apparatus,
the microprocessor is configured to acquire first information that designates the product identification information corresponding to the specific product in a state in which a value of at least part of variables of the product variable part is undefined and second information that designates a value of the variable in the undefined state, from the terminal apparatus, and
the microprocessor is configured to specify the product identification information corresponding to the specific product on a basis of the first information and the second information.

2. The server apparatus according to claim 1, wherein the microprocessor is configured to execute, in the acquisition of the information, a process of acquiring the first information from the terminal apparatus, a process of requesting the user through the terminal apparatus to designate a value of an undefined variable in the acquired first information, and a process of acquiring a value designated by the user in response to the request for designation of the value of the undefined variable, as the second information from the terminal apparatus.

3. The server apparatus according to claim 1, wherein,
the microprocessor is configured to change a value of at least part of the variables of the product variable part included in the product identification information specified by the product identification information specification means from the defined state into an undefined state on a basis of an instruction from the user given through the terminal apparatus, and
the microprocessor is configured to request, in the acquisition of the information, the user through the terminal apparatus to designate a value of the variable changed into the undefined state by the variable initializing means and acquires a value designated by the user as the second information from the terminal apparatus.

4. The server apparatus according to claim 1, wherein
the component selection system is configured as an ordering supporting system for allowing the user to order at least one component, and
component identification information provided by the microprocessor is used as information for selecting a component the user desires to purchase.

5. An information provision method for a component selection system in which,
for each of a plurality of products, product identification information unique to each product is set, the product identification information being a combination of a product common part set in common to products that are same in configuration except differences of specifications, and a product variable part set to different values depending upon the specifications, and
for each of a plurality of components configuring each product, component identification information unique to each component is set, the component identification information being a combination of a component common part set in common to components that are same in configuration except differences of specifications, and a component variable part set to different values depending upon the specifications,
the information provision method being applied to the component selection system in which values of the product variable part of the product identification information and values of the component variable part of the component identification information are associated with each other according to a predetermined rule,
information for allowing a user to select at least one component configuring a specific product being provided from a server apparatus to a terminal apparatus used by the user,
the information provision method performed by a microprocessor of the server apparatus comprising the steps of:
acquiring information for specifying the product identification information corresponding to the specific product from the terminal apparatus;
specifying the product identification information corresponding to the specific product on a basis of the information acquired by the information acquisition step;
specifying, on a basis of constituent component data that describes an associated relation between at least the product common part of the product identification information and at least the component common part of the component identification information, the component identification information associated with the product identification information specified by the product identification information specification step while defining a value of the component variable part associated with a value of the product variable part according to the predetermined rule; and
providing the component identification information specified by the component identification information specification step to the terminal apparatus, wherein,
in the acquisition of the information, first information that designates the product identification information corresponding to the specific product in a state in which a value of at least part of variables of the product variable part is undefined and second information that designates a value of the variable in the undefined state are acquired from the terminal apparatus, and
in the specification of the product identification information, the product identification information corresponding to the specific product is specified on a basis of the first information and the second information.

6. A non-transitory storage medium storing a computer program for causing a microprocessor of a server apparatus provided in a component selection system in which,
for each of a plurality of products, product identification information unique to each product is set, the product identification information being a combination of a product common part set in common to products that are same in configuration except differences of specifications, and a product variable part set to different values depending upon the specifications,
for each of a plurality of components configuring each product, component identification information unique to each component is set, the component identification information being a combination of a component common part set in common to components that are same in configuration except differences of specifications, and a component variable part set to different values depending upon the specifications, and
values of the product variable part of the product identification information and values of the component variable part of the component identification information are associated with each other according to a predetermined rule,
to function such that information for allowing a user to select at least one component configuring a specific product is provided to a terminal apparatus used by the user,
the computer program causing the microprocessor to execute the processes of:
acquiring information for specifying the product identification information corresponding to the specific product from the terminal apparatus;
specifying the product identification information corresponding to the specific product on a basis of the information acquired by the information acquisition means;
specifying, on a basis of constituent component data that describes an associated relation between at least the product common part of the product identification information and at least the component common part of the component identification information, the component identification information associated with the product identification information specified by the product identification information specification means while defining a value of the component variable part associated with a value of the product variable part according to the predetermined rule;
the component identification information specified by the component identification information specification means to the terminal apparatus;
acquiring first information that designates the product identification information corresponding to the specific product in a state in which a value of at least part of variables of the product variable part is undefined and second information that designates a value of the variable in the undefined state, from the terminal apparatus; and
specifying the product identification information corresponding to the specific product on a basis of the first information and the second information.
